(19) United States
(12) Patent Application Publication
(10) Pub. No.: US 2009/0133111 A1
(43) Pub. Date: May 21, 2009

(54) SYSTEM FOR CENTRALIZING PERSONAL IDENTIFICATION VERIFICATION AND ACCESS CONTROL

(75) Inventor: Reginald Delone Evans, Sumter, SC (US)

Correspondence Address: MCNAIR LAW FIRM, P.A., P.O. BOX 447, GREENVILLE, SC, 29602-0447, US

(73) Assignee: Evans Security Solutions, LLC, Sumter, SC (US)

(21) Appl. No.: 12/357,027

(22) Filed: Jan. 21, 2009

Related U.S. Application Data
(63) Continuation-in-part of application No. 11/905,887, filed on Oct. 5, 2007.
(60) Provisional application No. 60/924,212, filed on May 3, 2007.

(51) Int. Cl. H04L 9/32; G06F 21/00

(52) U.S. Cl. 726/9

(57) ABSTRACT

A computerized centralized access management system having an access card with personal identification information, a server in communication an access control computer having an access card reader, an add-on computer program stored in the access control computer to perform a method of reading the access card, retrieving personal identification information, transmitting personal information to the server, receiving an access record and notifying the access control computer whether or not to allow access for the individual according to said access record received from said server.

### CLAIM OF PRIORITY

This application is a continuation in part of U.S. patent application Ser. No. 11/905,887 filed Oct. 5, 2007 entitled Personal Verification Card Module#: 6800 which, in turn, claims priority on U.S. Provisional Patent Application Ser. No. 60/924,212 filed May 3, 2007.

### FIELD OF THE INVENTION

This invention is directed to a system for centralizing personal verification identification and access control for individuals desiring to enter or gain access to physical locations or other protected areas.

### BACKGROUND

In today's environment, there is a need for tighter physical security and controlled access to such items as computer systems, storage locations, and other physical facilities. Historically, we have used security personnel and physical keys to control access to such locations. More recently, we have used personal identification numbers for keypads, access cards, fingerprints, retinal prints and even facial recognition to control access to physical locations. However, to date there is no centralized method for using such identification means in a global or system-wide environment.

In the United States Government, there are thousands of agencies from the Administration for Children and Families to the White House. In order to gain access to federal governmental buildings, there are a number of technologies that are used which include Common Access Cards. These Common Access Cards presently have at least four formats, Geneva Convention Identification Cards, Geneva Convention Accompanying Forces Card, Identification and Privilege Card and Identification Card. However, these Common Access Cards are only used for military installations. Other governmental agencies use different technologies for allowing access to the physical facilities. For example, the U.S. Department of Housing and Urban Development uses the DSX Card Access System; the U.S. Treasury uses the Electronic Treasury Enterprise Card or E-trec; and the Department of Homeland Security is using identification cards that are based in PKI encryption. Unfortunately, for anyone that has to access more than one United States agency, that individual must apply for and be approved and granted an access card to enter that particular facility. Simply, one cannot use access cards for multiple departments.

The application process for obtaining any access card can include an application form, background check, and other process to insure that the individual requesting the access card should be granted a card. This process can be time-consuming and can lead to multiple efforts by differing agencies when an individual applies for access to differing agencies.

It would be advantageous to have a system that allowed for a single access card to contain sufficient information to allow individuals to have access to multiple governmental departments without the need to apply for and obtain multiple access cards from differing agencies. It would also be advantageous to have a system for allowing access to multiple agencies that can be centrally managed so that access rights can be updated and thereafter applied across multiple agencies or departments.

### SUMMARY OF THE INVENTION

The above objectives are accomplished by providing a computerized centralized access management system comprising: an access card having personal identification information associated with an individual; a server which communicates with an access control computer, wherein the access control computer has an access card reader; an add-on computer program stored in the access control computer that when executed by the access control computer causes the access control computer to perform a method of reading the access card, retrieving the personal identification information from the access card, transmitting the personal information to the server, receiving an access record from the server and notifying the access control computer whether or not to allow access for the individual according to the access record received from the server; a set of access records stored on the server representing access levels for physical locations associated with an individual; and, a server computer program stored in the server that when executed by the server causes the server to perform a method of receiving the personal identification information from the access control system, retrieving an access record from the set of access records according to the personal identification information and transmitting the access record to the access control computer so that the access control computer can determine whether the individual can have physical access to the facility.

The access card has readable media selected from the group of printed text, smart card chip, barcode, RFID chip, and magnetic strip containing personal identification information and the smart card chip can contain personal identification information selected from the group of fingerprints, retinal image, DNA information, voice print information, handwriting, handprint, keystroke information and facial characteristics. The smart card chip can also contain medical information.

The add-on computer program stored in the access control computer can also include instruction for retrieving a first type of personal identification information from the access card selected from the group of fingerprints, retinal image, DNA information, voice print information, handwriting, handprint, keystroke information, and facial characteristics, retrieving a second type of personal identification information from the access card selected from the group of fingerprints, retinal image, DNA information, voice print information, handwriting, handprint, keystroke information and facial characteristics, notifying the access control computer whether or not to allow access for the individual according to the access record received from the server, the first type of personal identification information and the second type of personal identification information.

The access record can include biometric information selected from the group of fingerprints, retinal image, facial characteristics, DNA information, voice print information and handprint and the add-on computer program stored in the access control computer that when executed by the access control computer causes the access control computer to perform a method of receiving biometric information from a biometric reader included in the access control system, comparing the biometric information with the access record and notifying the access control computer whether or not to allow access for the individual according to the access record received from the server.

A computerized centralized access management system comprising an access card having personal identification information associated with an individual, a server which communicates with a computer system, wherein the computer system is in communications with an access card reader, an add-on computer program stored in the computer system that when executed by the computer system causes the computer system to perform a method of reading the access card, retrieving the personal identification information from the access card, transmitting the personal information to the server, receiving an access record from the server and notifying the computer system whether or not to allow access for the individual according to the access record received from the server, a set of access records stored on the server representing access levels for various areas of the computer system associated with an individual, and a server computer program stored in the server that when executed by the server causes the server to perform a method of receiving the personal identification information from the computer system, retrieving an access record from the set of access records according to the personal identification information and transmitting the access record to the computer system so that the computer system can determine whether the individual can have access to the computer system.

### DESCRIPTION OF THE DRAWINGS

FIG. 1 is a schematic of the invention;

FIG. 2 is a schematic of the invention;

FIG. 3 is a flowchart of the invention; and,

FIG. 4 is a flowchart of the invention.

### DESCRIPTION OF THE INVENTION

A set of computer readable instruction is a section of computer readable code embodied in a computer that represents physical items that can be manipulated by such computer. The detailed description that follows may be presented in terms of program procedures executed on a computer or network of computers. These procedural descriptions are representations used by those skilled in the art to most effectively convey the substance of their work to others skilled in the art. These procedures herein described are generally a self-consistent sequence of steps leading to a desired result. Data, data sets, information and other such items represent physical items that can be manipulated or transformed by the computer readable instructions and steps. These steps require physical manipulations of physical quantities such as electrical or magnetic signals capable of being stored, transferred, combined, compared, or otherwise manipulated readable medium that is designed to perform a specific task or tasks. Actual computer or executable code or computer readable code may not be contained within one file or one storage medium, but may span several computers or storage mediums. The term “host” and “server” may be hardware, software, or combination of hardware and software that provides the functionality described herein.

The present invention is described below with reference to flowchart illustrations of methods, apparatus (“systems”) and computer program products according to the invention. It will be understood that each block of a flowchart illustration can be implemented by a set of computer readable instructions or code. These computer readable instructions may be loaded onto a general purpose computer, special purpose computer, or other programmable data processing apparatus to produce a machine such that the instructions will execute on a computer or other data processing apparatus to create a means for implementing the functions specified in the flowchart block or blocks.

These computer readable instructions may also be stored in a computer readable medium that can direct a computer or other programmable data processing apparatus to function in a particular manner, such that the instructions stored in a computer readable medium produce an article of manufacture including instruction means that implement the functions specified in the flowchart block or blocks. Computer program instructions may also be loaded onto a computer or other programmable apparatus to produce a computer executed process such that the instructions are executed on the computer or other programmable apparatus to provide steps for implementing the functions specified in the flowchart block or blocks. Accordingly, elements of the flowchart support combinations of means for performing the special functions, combination of steps for performing the specified functions and program instruction means for performing the specified functions. It will be understood that each block of the flowchart illustrations can be implemented by special purpose hardware-based computer systems that perform the specified functions, or steps, or combinations of special purpose hardware or computer instructions. The present invention is now described more fully herein with reference to the drawings in which the preferred embodiment of the invention is shown. This invention may, however, be embodied in many different forms and should not be construed as limited to the embodiment set forth herein. Rather, these embodiments are provided so that this disclosure will be thorough and complete and will fully convey the scope of the invention to those skilled in the art.

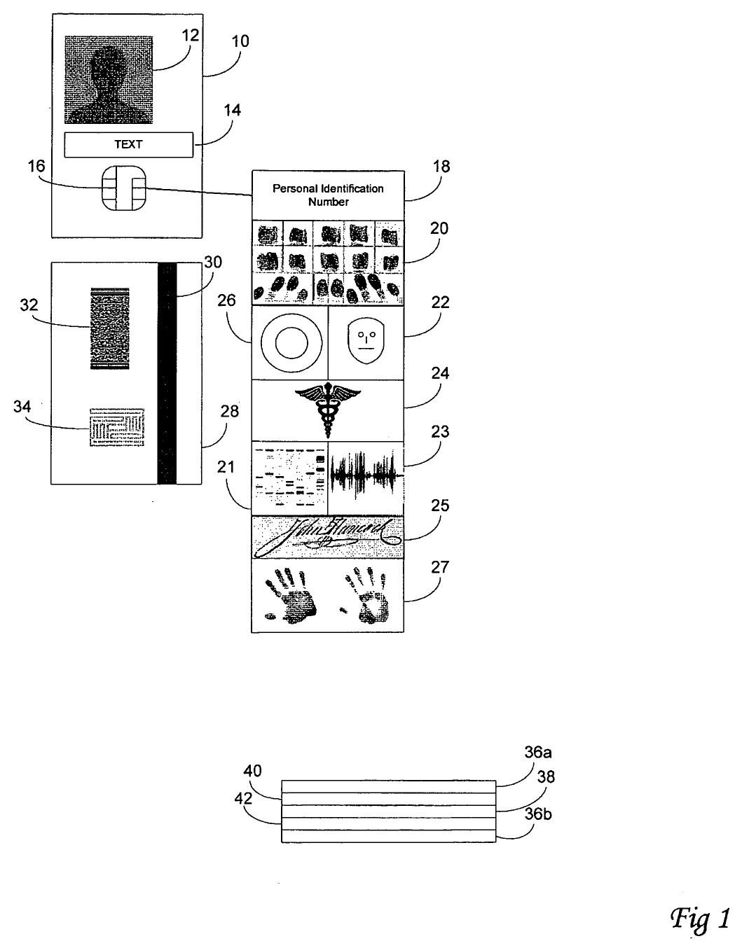

Referring now to FIG. 1, a schematic of a universal smart card is shown. In one embodiment, the access card is between 5.0 and 5.5 cm wide with a thickness between 25 and 35 mm. The front of the card 10 contains a photo 12 of the individual associated with the access card, textual information 14 concerning the individual, a computer readable medium 16 and a set of personal identification information 18. In one embodiment, the computer readable memory contains up to 10 gigabits of storage space. In one embodiment, the computer readable memory contains personal identification information associated with the individual associated with the access card. Such personal information can contain a personal identification number 18 and biometric information such as fingerprints 20, retinal image 22, facial characteristics 24, DNA information 21, voice print information 23, handwriting 25, and keystroke and handprint information 27. The computer readable memory can also include medical records 26. The back of the access card 28 contains a magnetic strip 30, barcode 32 and RFID chip 34. The magnetic strip can contain information such as an identification number associated with the individual assigned to the access card, the individual's name of other identifying information. The barcode can also contain identification number associated with the individual assigned to the access card, the individual's name or other identifying information. The RFID chip can also contain an identification number associated with the individual assigned to the access card, the individual's name or other identifying information. The computer readable memory contained on the access card is read-write allowing for the access card to be updated. Security such as PKI can be used to protect the information contained on the compute readable memory.

In one embodiment, the access card has protective layers 36a and 36b. Within the protective layers is a hologram layer 38. The computer readable medium can be in layer 40 with the RFID contained in layer 42.

In one embodiment, the access card shall comply with the physical characteristics of International Electro Technical Commission (IEC) 7810, International Organization for Standardization (ISO) 7810, IEC/ISO 10373, ISO/IEC 7816 and ISO/IEC 14443. In one embodiment, one or more layers of the access card contains one or more of optically varying structures, optically varying ink, laser etching, laser engraving, holographic images, and watermarks. The computer readable medium can be a contactless ICC chip in one embodiment.

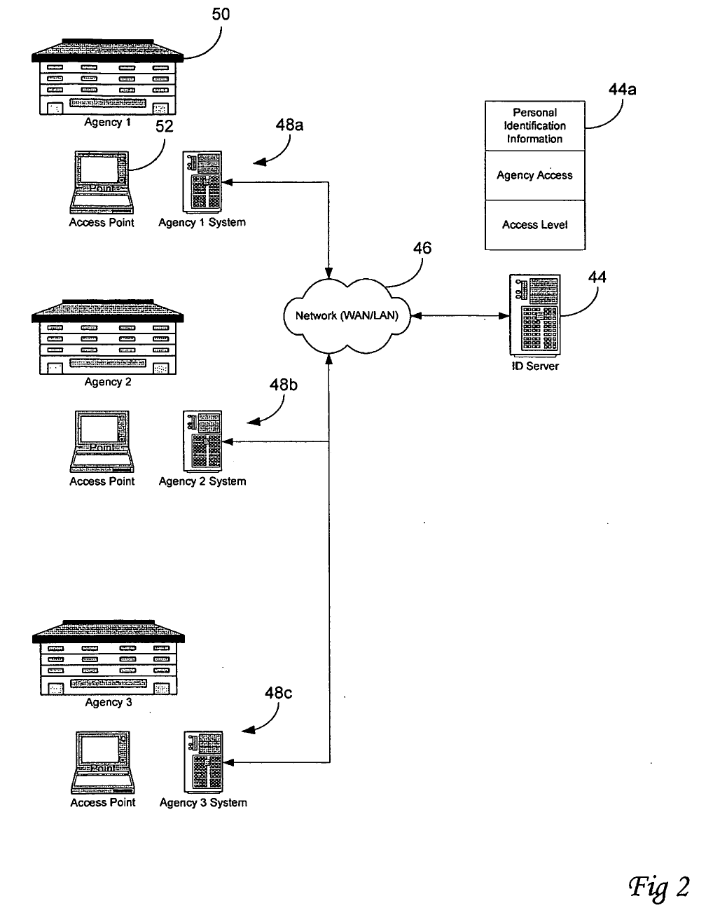

Referring now to FIG. 2, the hardware and software associated with this invention is described in more detail. A server 44 is connected through network 46 to various agencies physical access systems shown generally as 48a, 48b and 48c. Each of the agencies may have a different physical protocol, based upon several factors, to grant or deny access to the physical facility. For example, one facility may have a card reader that reads the barcode or magnetic strip on the card to match the personal identification information with access rights to determine if that card will allow access to the facility. Another facility may require a heightened access protocol and use a biometric reader that can read fingerprint and retinal scans before allowing access. Server 44 allows a centralized management of individuals and their access levels that can be accessed by various agencies.

In order to provide the functionality of this invention, one embodiment uses an add-on computer program, computer readable instructions, that can be installed on an access control computer for a facility such as the PIV Solution offered by ImageWare Systems, Inc. The add-on computer program allows the access control computer to retrieve personal identification information from the access card, retrieves an access record from the server according to the personal identification information and notifies the access control computer whether access should be granted to the individual.

Access information stored on the server can contain personal identification information 44a, information representing which agencies or physical locations the individual is allowed to access shown as 44b and the access level for that respective agency shown as 44c. For example, an individual may be allowed to access HUD to an access level of 2, FEMA to an access level of 4, and not allowed to access anything other than the “A” ring of the Pentagon. Therefore, this invention allows the user of the access cards to be granted or denied access across federal, state and local government facilities.

Computer readable instructions embodied in a computer readable medium of the Server contains instructions for receiving personal identification information from a user associated with an individual that wishes to gain physical access to one or more facilities, receiving agency information representing which agency or facility the individual is allowed to access, and receiving access level information representing the level of access associated with the individual for each agency or facility the individual can access. This centralized management is advantageous as it allows access to be granted or denied to an individual from one source without the need to duplicate access information for each agency or facility involved.

Once an individual attempts to access agency 50, for example, through access point 52, the agency access system 48a reads at least one of personal information from the access card. The computer readable instructions at the agency access system then attempts to retrieve a matching record from a local database to determine whether the individual can access the location and if so, what access level is associated with the individual. If the individual is authorized to access the location and has the appropriate access level, the individual is allowed access. In one embodiment, the agency access system attempts to retrieve a matching record from the Server.

In one embodiment, the access control computer may require two or more forms of checking the personal identity of the individual to determine access. For example, the individual may have to provide an access card with the magnetic strip required to have certain information. The individual may also have to provide a fingerprint to the access control computer. With these two items of personal identification, the access level of the individual can be retrieved from the centralized server and transmitted to the access control computer so that the access control computer knows whether to allow access.

When the information contained in the server is modified, the access information can be transmitted to the appropriate agencies or can be requested from the agency access control system so that the information will be updated both at the server and the agency access control system. In one embodiment, there is no local database at the access control point containing access information and therefore no need to have the information on the server sent to the agency access system.

In one embodiment, this invention is designed to allow or prevent access to a computer system. The access control point is in communication with the computer system and when a user wishes to use a computer system, the user presents the access card to the card reader and cased upon the access record returned from the server, as described herein, the user is either allowed or denied access to the computer system. Additionally, the user may be only allowed access to certain portions of the computer system based upon the security level. In this embodiment, there is an add-on computer program that is embodied in the computer terminal that is desired to be accessed that receives the personal identification information, transmits the personal identification information to the server, receives an access record and allow of denies access according to the received access record.

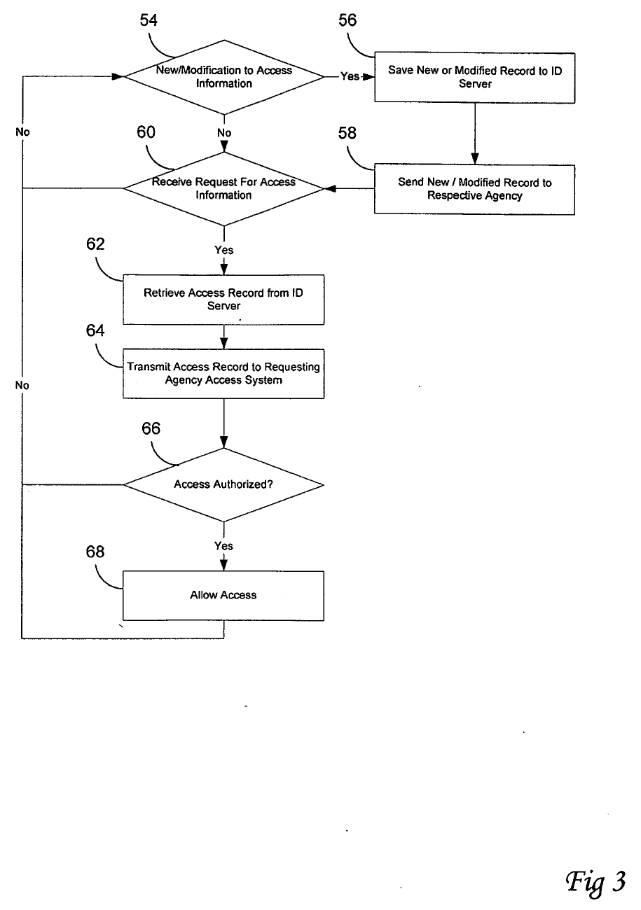

Referring to FIG. 3, the operation of the invention is described in more detail. At 54, a determination is made as to whether a new access record has been added to the server or whether an existing access record on the server has been modified. If so, the new or modified access record is stored in the computer readable medium of the server at 56 and transmitted to the respective agency access system at 58. At 60, a determination is made as to whether any agency access system is requesting the access information of an individual. If so, the access record associated with the personal identification information from the access card used at the agency access system is retrieved. At 64, the retrieved access record is transmitted to the agency access system. Once the agency access system receives the access record, the agency system determines whether to grant or deny access at 66. If it is determined that the individual is granted access, access is granted at 68.

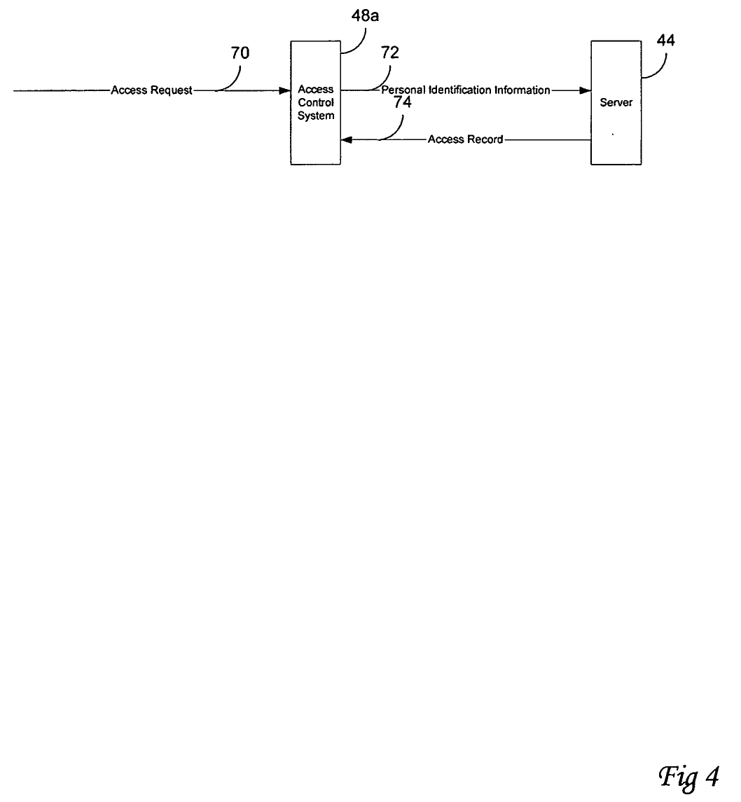

Referring to FIG. 4, an access request 70 is transmitted to the access control system 48a from an access point device such as a card reader, optical scanner or some other access point device. The personal identification information 72 associated with the individual attempting to gain access is transmitted to ID server 44. The ID server retrieves the associated access record 74 and transmits it back to the access control system. In one embodiment, the access control system also transmits access control system identification information representing the type of access system used. In response, the ID server can format the access record according to the type of access control system so that the access control system receives access information in a format understandable to the access control system.

While a preferred embodiment of the invention has been described using specific terms, such description is for illustrative purposes only, and it is to be understood that changes and variations may be made without departing from the spirit or scope of the following claims.

What is claimed is:

1. A computerized centralized access management system comprising:
an access card having personal identification information associated with an individual;
a server which communicates with an access control computer, wherein the access control computer has an access card reader;
an add-on computer program stored in the access control computer that when executed by the access control computer causes the access control computer to perform a method of reading said access card, retrieving said personal identification information from said access card, transmitting said personal information to said server, receiving an access record from said server and notifying the access control computer whether or not to allow access for the individual according to said access record received from said server;
a set of access records stored on said server representing access levels for physical locations associated with an individual; and,
a server computer program stored in the server that when executed by said server causes the server to perform a method of receiving said personal identification information from the access control system, retrieving an access record from said set of access records according to said personal identification information and transmitting said access record to the access control computer so that the access control computer can determine whether the individual can have physical access to the facility.

2. The system of claim 1 wherein said access card has readable media selected from the group of printed text, smart card chip, barcode, RFID chip, and magnetic strip containing personal identification information.

3. The system of claim 1 wherein said access card includes a smart card chip containing personal identification information selected from the group of fingerprints, retinal image, DNA information, voice print information, handwriting, handprint, keystroke information and facial characteristics.

4. The system of claim 1 wherein said access card includes a smart card chip containing medical information.

5. The system of claim 1 wherein said set of access records includes access levels representing discrete areas of a physical location that is accessible to the individual.

6. The system of claim 1 wherein said an add-on computer program stored in the access control computer that when executed by the access control computer causes the access control computer to perform a method of retrieving a first type of personal identification information from said access card selected from the group of fingerprints, retinal image, DNA information, voice print information, handwriting, handprint, keystroke information, and facial characteristics, retrieving a second type of personal identification information from said access card selected from the group of fingerprints, retinal image, DNA information, voice print information, handwriting, handprint, keystroke information and facial characteristics, notifying the access control computer whether or not to allow access for the individual according to said access record received from said server, said first type of personal identification information and said second type of personal identification information.

7. The system of claim 1 wherein:
said access record include biometric information selected from the group of fingerprints, retinal image, facial characteristics, DNA information, voice print information and handprint; and,
said add-on computer program stored in the access control computer that when executed by the access control computer causes the access control computer to perform a method of receiving biometric information from a biometric reader included in the access control system, comparing said biometric information with said access record and notifying the access control computer whether or not to allow access for the individual according to said access record received from said server.

8. A computerized centralized access management system comprising:
an access control computer having an access card reader;
an access card having personal identification information associated with an individual;
a server which communicates with said access control computer having a set of access records stored on said server representing access levels for physical locations associated with an individual;
an access control program stored in said access control computer that when executed by said access control computer causes the access control computer to perform a method of reading said access card, retrieving said personal identification information from said access card, transmitting said personal information to said server, receiving an access record from said set of access records and determining whether or not to allow access for the individual according to said access record received from said server; and,
a server computer program stored in the server that when executed by said server causes the server to perform a method of receiving said personal identification information from the access control system, retrieving an access record from said set of access records according to said personal identification information and transmitting said access record to the access control computer so that the access control computer can determine whether the individual can have physical access to the facility.

9. The system of claim 8 wherein said access card has readable media selected from the group of printed text, smart card chip, barcode, RFID chip, and magnetic strip containing personal identification information.

10. The system of claim 8 wherein said access card includes a smart card chip containing personal identification information selected from the group of fingerprints, retinal image, DNA information, voice print information, handwriting, handprint, keystroke information and facial characteristics.

11. The system of claim 8 wherein said access card includes a smart card chip containing medical information.

12. The system of claim 8 wherein said set of access records includes access levels representing discrete areas of a physical location that is accessible to the individual.

13. The system of claim 8 wherein said an add-on computer program stored in the access control computer that when executed by the access control computer causes the access control computer to perform a method of retrieving a first type of personal identification information from said access card selected from the group of fingerprints, retinal image, DNA information, voice print information, handwriting, handprint, keystroke information, and facial characteristics, retrieving a second type of personal identification information from said access card selected from the group of fingerprints, retinal image, DNA information, voice print information, handwriting, handprint, keystroke information, and facial characteristics, notifying the access control computer whether or not to allow access for the individual according to said access record received from said server, said first type of personal identification information and said second type of personal identification information.

14. The system of claim 8 wherein:
said access record include biometric information selected from the group of fingerprints, retinal information, facial recognition information, DNA information, voice information and handprint information; and,
said add-on computer program stored in the access control computer that when executed by the access control computer causes the access control computer to perform a method of receiving biometric information from a biometric reader included in the access control system, comparing said biometric information with said access record and notifying the access control computer whether or not to allow access for the individual according to said access record received from said server.

15. An access card comprising:
media selected from the group of printed text, smart card chip, barcode, RFID chip, and magnetic strip containing personal identification information;
said smart card chip includes personal identification information selected from the group of fingerprints, retinal image, DNA information, voice print information, handwriting, handprint, keystroke information, and facial characteristics; and,
whereby said personal identification information is read from said access card by a access card reader included in an access control computer having an add-on computer program stored in the access control computer that when executed by the access control computer causes the access control computer to perform a method of reading said access card, retrieving said personal identification information from said access card, transmitting said personal information to a server, receiving an access record from the server and notifying the access control computer whether or not to allow access for the individual according to said access record received from the server and whereby the server includes a set of access records stored on said server representing access levels for physical locations associated with an individual and a server computer program stored in the server that when executed by said server causes the server to perform a method of receiving said personal identification information from the access control system, retrieving an access record from said set of access records according to said personal identification information and transmitting said access record to the access control computer so that the access control computer can determine whether the individual can have physical access to the facility.

16. The card of claim 14 wherein said access card includes a smart card chip containing medical information.

17. A computerized centralized access management system comprising:
an access card having personal identification information associated with an individual;
a server which communicates with a computer system, wherein the computer system is in communications with an access card reader;
an add-on computer program stored in the computer system that when executed by the computer system causes the computer system to perform a method of reading said access card, retrieving said personal identification information from said access card, transmitting said personal information to said server, receiving an access record from said server and notifying the computer system whether or not to allow access for the individual according to said access record received from said server;
a set of access records stored on said server representing access levels for various areas of the computer system associated with an individual; and,
a server computer program stored in the server that when executed by said server causes the server to perform a method of receiving said personal identification information from the computer system, retrieving an access record from said set of access records according to said personal identification information and transmitting said access record to the computer system so that the computer system can determine whether the individual can have access to the computer system.

18. The system of claim 17 wherein said access card has readable media selected from the group of printed text, smart card chip, barcode, RFID chip, and magnetic strip containing personal identification information.

19. The system of claim 17 wherein said access card includes a smart card chip containing personal identification information selected from the group of fingerprints, retinal image, DNA information, voice print information, handwriting, handprint, keystroke information and facial characteristics.

20. The system of claim 17 wherein said set of access records includes access levels representing discrete areas of the computer system that is accessible to the individual.

21. The system of claim 17 wherein:
said access record include biometric information selected from the group of fingerprints, retinal image, facial characteristics, DNA information, voice print information and handprint; and,
said add-on computer program stored in the computer system that when executed by the access control computer causes the access control computer to perform a method of receiving biometric information from a biometric reader in communication with the computer system, comparing said biometric information with said access record and notifying the computer system whether or not to allow access for the individual according to said access record received from said server.
